(19) United States
(12) Patent Application Publication
(10) Pub. No.: US 2003/0220145 A1
(43) Pub. Date: Nov. 27, 2003

(54) Digital camera and networking accessories for a portable video game device

(76) Inventors: Craig S. Erickson, Stevenson Ranch, CA (US); Herschel Naghi, Los Angeles, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/278,168

(22) Filed: Oct. 21, 2002

Related U.S. Application Data
(60) Provisional application No. 60/383,238, filed on May 22, 2002.

(51) Int. Cl. A63F 13/00

(52) U.S. Cl. 463/47

(57) ABSTRACT

A portable video game accessory capable of loading an operating code into a portable video game device is provided. The portable video game accessory may be a digital camera accessory that works together with the portable video game device to work as a digital camera. The portable video game accessory may also be a networking accessory that works together with the portable video game device as a wireless communicator. The portable video game accessory includes processing circuitry capable of receiving a random number from the portable video game device. The portable video game accessory also includes an i/o port suitable for being coupled to the portable video game device and a memory capable of storing the operating code and the random number. The processing circuitry encrypts the operating code using the random number and provides the encrypted operating code to the portable video game device through the i/o port to operate the portable video game device.

### CROSS REFERENCE TO RELATED APPLICATION(S)

This application claims priority of U.S. Provisional Patent Application No. 60/383,238 entitled “Portable Video Game Accessories,” filed May 22, 2002, the contents of which are fully incorporated by reference herein.

### FIELD OF THE INVENTION

The present invention is related to accessories for portable video game devices, and particularly to accessories and method for digital video/photography and wireless communication using the portable video game devices.

### BACKGROUND

Some of the portable video game devices on the market have a port for connecting them to another video game device and/or to other types of devices, such as a personal computer. For example, Nintendo® manufactures and distributes Game Boy Advance® (GBA) having a mini-USB (Universal Serial Bus) port for connecting it to other GBAs. Nintendo® and Game Boy Advance® are registered trademarks of Nintendo of America Inc., a Washington corporation, Redmond, Wash.

The Nintendo design of the mini-USB port on the GBA allows several interface functions. One of these is a high-speed serial play link between GBAs. One of the primary features of this is that it allows the purchase of only one GBA game cartridge to play a multi-player game with other GBA users. For example, with Nintendo's multi-boot sequence in a multi-boot mode, the GBA can download program code from the purchased cartridge into the other connected GBAs and allow linked game play between the connected GBAs.

The mini-USB port also allows the GBA to be attached to a Nintendo GameCube® and with certain selected games, the GBA can become a controller for the Nintendo GameCube®. Nintendo GameCube® is a registered trademarks of Nintendo of America Inc., a Washington corporation, Redmond, Wash.

In both of the above cases, the GBA downloads code from another Nintendo product. It is not generally known, however, to provide a non-Nintendo accessory product that loads its operating code via the GBA's mini-USB port without a cartridge.

### SUMMARY OF THE INVENTION

In an exemplary embodiment according to the present invention, a portable video game accessory is provided. The portable video game accessory is capable of loading an operating code into a portable video game device having a display panel and a plurality of buttons. The portable video game accessory includes: processing circuitry capable of receiving a random number from the portable video game device; an i/o port suitable for being coupled to the portable video game device; and a memory capable of storing the operating code and the random number, wherein the processing circuitry encrypts the operating code using the random number and provides the encrypted operating code to the portable video game device through the i/o port. The operating code enables a user to control the portable video game accessory using the buttons of the portable video game device and to display an output of the portable video game accessory on the display panel.

In another exemplary embodiment according to the present invention, a method of loading an operating code into a portable video game device from a portable video game accessory is provided. The portable video game device has a display panel and a plurality of buttons. The method includes: sending a signal from the portable video game accessory to the portable video game device to send a random number; generating the random number in the portable video game device; sending the random number to the portable video game accessory; sending an operating code from the portable video game accessory to the portable video game device; and booting the portable video game device using the operating code from the portable video game accessory. The operating code enables a user to control the portable video game accessory using the buttons of the portable video game device and to display an output of the portable video game accessory on the display panel.

### BRIEF DESCRIPTION OF THE DRAWINGS

These and other aspects of the invention may be understood by reference to the following detailed description, taken in conjunction with the accompanying drawings, wherein:

FIG. 1A is a diagram of a digital camera formed from mounting a digital camera accessory on a portable video game device in an exemplary embodiment according to the present invention;

FIG. 1B is a diagram of a camera head portion of a digital camera accessory in an exemplary embodiment according to the present invention;

FIG. 1C is a side view of the digital camera of FIG. 1A;

FIG. 1D is a rear view of the digital camera of FIG. 1A;

FIG. 1E illustrates a rear outline view of how a digital camera accessory and/or a networking accessory can be mounted on a portable video game device in embodiments according to the present invention;

FIG. 2 is a block diagram of a digital camera accessory in an exemplary embodiment according to the present invention;

FIG. 3 illustrates pin connections between a portable video game accessory (a digital camera accessory or a networking accessory) and a portable video game device in an exemplary embodiment according to the present invention;

FIG. 4 illustrates a flow diagram of a synchronization process between a portable video game accessory (a digital camera accessory or a networking accessory) and a portable video game device in an exemplary embodiment according to the present invention;

FIG. 5 is a block diagram of a networking accessory in an exemplary embodiment according to the present invention; and

FIG. 6 is a thumb board (thumb operated keyboard) of a networking accessory in an exemplary embodiment according to the present invention.

### DETAILED DESCRIPTION

An exemplary embodiment according to the present invention includes a portable video game accessory (a digital camera accessory or a networking accessory) which is a compact clip-on device for a portable video game device (or a portable video game console), such as, for example, Game Boy Advance (GBA).

The digital camera accessory, when used together with the portable video game device as a digital camera, takes digital pictures and allows viewing and editing on the portable video game device. The digital camera, for example, may be used to take snapshots of the scenery to generate digital pictures. The digital camera may also be used to edit the digital pictures. Further, the digital camera may be used as a video camera to capture a video stream. When the portable video game device is equipped with a PC (personal computer) transfer link, the digital camera may download and/or upload pictures to and from a PC.

In the exemplary embodiment, the digital camera accessory loads an operating code (which may also be referred to as a boot code, a program code or an application code) into a portable video game device over the mini-USB port of the portable video game device. For example, when the portable video game device is a Nintendo GBA, when loading the operating code (i.e., program code) over the mini-USB port, the exemplary digital camera accessory emulates a Nintendo product to have the GBA to enter a multi-boot mode and allow the operating code to be downloaded into the GBA from the digital camera accessory. Once the operating code is inside the GBA, the GBA then may be controlled by the digital camera accessory (or its operating code). In the exemplary embodiment, the digital camera accessory slips onto the GBA and the only electrical/logical connection to it is via the mini-USB port.

In another exemplary embodiment according to the present invention, a networking accessory may be coupled to the portable video game device through the mini-USB port to work with the portable video game device as a wireless communicator (i.e., a networking device). For example, the networking accessory may load its operating code to the portable video game device in a manner similar to the digital camera accessory. The exemplary networking accessory may also use the game slot of the portable video game device for mechanical coupling between the two. The networking accessory, for example, may also be referred to as a wireless communicator accessory, a network accessory, a networker accessory or as a networker.

The networking accessory may include an RF transceiver (e.g., operating at 27 MHz radio frequency) for the wireless communicator to link to other wireless communicators or other communications devices. For example, the wireless communicator may have a range of 200 ft to 1000 ft in an exemplary embodiment. In a sense, the networking accessories may be used to create a small private network of networking devices based on the portable video game device.

The networking accessory may have a small text input device such as a thumb operated keypad (which may also be referred to as a thumb board or a thumb pad) or a keyboard (e.g., 10×4 keyboard matrix) for such applications as e-mail, chatting, instant messaging and the like. The networking device may also be used as a personal data assistant (PDA) or a calculator. The networking accessory may also have a voice transmitter (and a microphone) and receiver for voice communications. At the receiving end, the transmitted voice may be regenerated using a portable video game device's speaker, for example. Thus, the networking device may operate as a digital/analog messaging communicator of voice and data.

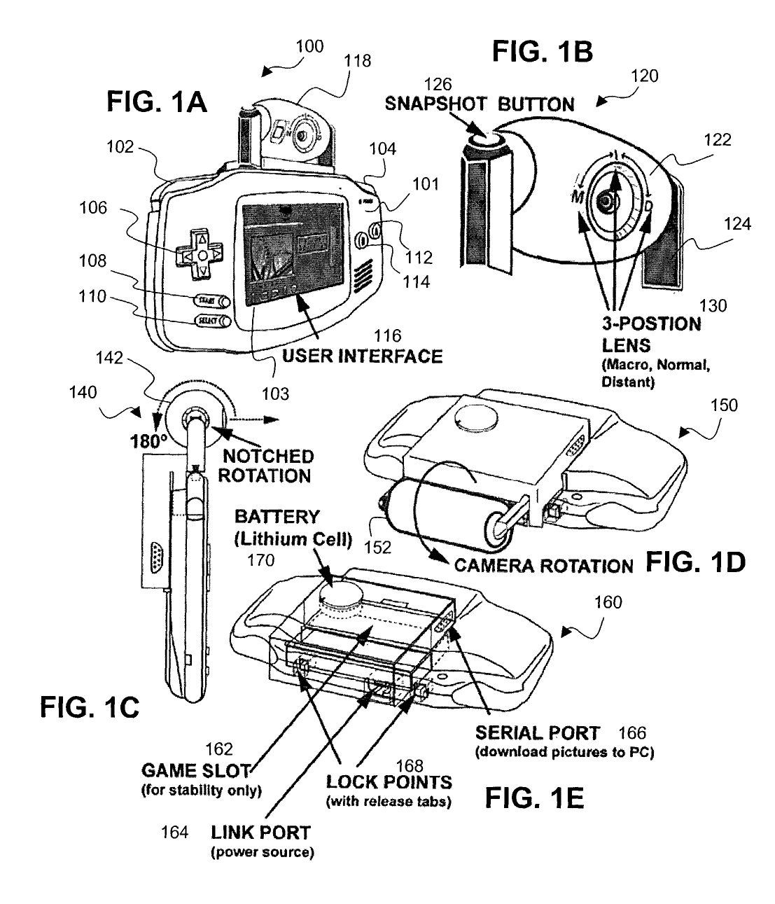

FIG. 1A is a diagram of a digital camera 100 formed from mounting a digital camera accessory 118 on a portable video game device 101 in an exemplary embodiment according to the present invention. The digital camera accessory 118 has a body portion and a camera head portion. In FIG. 1A, the body portion is hidden from view behind the portable video game device 101, and only the camera head portion is visible. The portable video game device 101, for example, may be a Nintendo GBA. As can be seen on the digital camera 100, a user interface display 116 for the digital camera 100 may be displayed on a GBA screen 103.

The user interface display 116 may, for example, look like the back of a typical digital camera. Further, the user interface display may have an area (e.g., a display window of about a quarter of its size) that displays a ‘thumbnail’ image of the image being captured. The user interface display 116 may also include the display of all digital camera functions and an application menu. The digital camera functions may include one or more of, but not limited to: 1) the percentage of memory left; 2) counter for number of pictures taken out of maximum possible; and 3) a ‘ready’ indicator.

The ‘ready’ indicator, for example, may be green when the digital camera is fully ready and the last picture has been saved into archive memory. Further, the ‘ready’ indicator may be orange or red when taking another picture will lose the existing image. In addition, the available memory indicator may be red if no image can be taken at that particular moment.

The portable video game device 101 may include one or more of, but not limited to, the following input devices: 1) a left shoulder button 102; 2) a right shoulder button 104; 3) a direction pad 106; 4) a start button 108; 5) a select button 110; 6) an ‘A’ button 112; and 7) a ‘B’ button 114. The portable video game device 101 may also include a speaker for outputting audible sound. In other embodiments, the portable video game device 101 may include other input mechanism (e.g., buttons, direction pad, etc.).

FIG. 1B is a diagram of a camera head portion of a digital camera accessory 120 in an exemplary embodiment according to the present invention. The digital camera accessory 120 includes a camera head 122 mounted on posts 124. In an exemplary embodiment, a snapshot button 126 may be mounted on one of the posts. The snapshot button 126, for example, may be used to take pictures.

In other embodiments, the snapshot button may not be provided. Instead, for example, the buttons and/or the direction pad 106 on the portable video game device 101 may be used for all operations of the digital camera 100 including, but not limited to, taking pictures. For instance, the left shoulder button 102 and/or the right shoulder button 104 may be used to take pictures. Further, the buttons and the direction pad 106 may be used to edit the digital pictures.

The camera head 122 includes a 3-position lens 130. The 3-position lens 130, for example, may be adjusted mechanically and/or electronically to take pictures of near (e.g., at ‘Macro’ position), far (e.g., at ‘Distant’ position) and in-between (e.g., at ‘Normal’ position) objects. In other embodiments, the lens may be adjustable to more or less than three positions. In still other embodiments, automatic focus may be provided. In further embodiments, the camera head 122 may also include a view finder.

FIG. 1C is a side view 140 of the digital camera 100 of FIG. 1A. The side view 140 of the digital camera (including the digital camera accessory and the portable video game device) illustrates that a camera head 142 of the digital camera accessory can be rotated (e.g., in a notched manner) 180 degrees about an axis between the posts on which it is mounted. In other embodiments, the maximum rotation can be more or less than 180 degrees (e.g., from fixed to 360 degrees).

In the exemplary embodiment, the digital camera accessory may include a sensor for tracking the rotation angle of the camera head so that the angular position of the camera head 142 may be available to the digital camera accessory, the portable video game device and/or any other electronic device coupled to the digital camera accessory.

FIG. 1D is a rear view 150 of the digital camera of FIG. 1A. The rear view 150 of the digital camera also illustrates rotation of a camera head 152.

FIG. 1E illustrates a rear outline view of how a digital camera accessory and/or a networking accessory (i.e., portable video game accessory) can be mounted on a portable video game device (e.g., Nintendo GBA) in exemplary embodiments according to the present invention.

The portable video game accessory (a digital camera accessory or a networking accessory) includes a slot for battery 170, which may be a lithium cell. The battery, for example, may be used to provide backup power to the SRAM on the digital camera accessory, on which digital pictures can be stored. The battery power supplied to the SRAM (static random access memory), for example, may allow the digital camera accessory to store the digital pictures until they are deleted. The digital pictures may also be stored on the GBA itself for a certain duration.

The portable video game accessory also includes a serial port 166 for coupling to a PC. The digital camera accessory, for example, can download pictures to (or upload pictures from) a PC through the serial port 166. The portable video game accessory in exemplary embodiments may download an operating code into the portable video game device through the mini-USB port (e.g., link port 164). The portable video game accessory may also receive power from the portable video game device through the mini-USB port.

The serial port 166 and/or the mini-USB port 164 may also be used to download additional software modules into the portable video game accessory. For example, editor software (e.g., for color editing) may be downloaded into the serial port of a digital camera accessory. When the editor software resides in the digital camera accessory, less memory may be available for storing digital pictures. For another example, software patch may be downloaded into a portable video game accessory. The software patch, for example, may be used to update the software in the portable video game accessory, e.g., to a new version.

It should be noted that a game slot (i.e., slot for game cartridges) 162 of the portable video game device is used only for mechanical coupling between the portable video game accessory and the portable video game device. In other words, the game slot on the portable video game device is used only as a support for clipping the portable video game accessory onto the portable video game device. In the exemplary embodiment, the portable video game accessory does not connect with the portable video game device through the game slot electronically. In other embodiments, the portable video game accessory may make one or more electrical connections with the portable video game device through the game slot.

Returning now to FIG. 1A, in an exemplary embodiment according to the present invention, the direction pad 106 of the digital camera 100, for example, can be used to select different modes of operation, which may include one or more of, but not limited to: 1) a “photo snap” mode for taking pictures; 2) a “photo edit” mode for editing pictures; 3) a “spy-cam” mode for continuously taking pictures at intervals; 4) a “slide show” mode for viewing the archived pictures one by one; and 5) a “PC link” mode for formatting, receiving and/or sending pictures.

In the photo snap mode, the digital camera 100 may be held out in front of the user similar to a digital camera having an LCD (e.g., TFT) screen to take a picture (i.e., capture an image). The user may use a finger (e.g., index finger) of his right hand to press the right shoulder button 104 of FIG. 1B to take the picture. When the right shoulder button 104 is squeezed, for example, the digital camera 100 may output a sound sample of a camera shutter over the speaker of the portable video game device.

In addition, the digital camera 100 may display a ‘thumbnail’ image of the captured image on the display window of the user interface display 116. Further, the user may press another button (e.g., the left shoulder button) to toggle between full screen image and ‘thumbnail’ image modes. A captured image may be deleted, for example, by pressing the “B” button 114 while viewing either the full screen image or the ‘thumbnail’ image.

Taking a picture should not wipe out any previously taken picture that has not been saved yet. If enough time has elapsed, a quality version of the image will have been transferred to the portable video game device, processed, converted back to a compressed image and moved back to the digital camera accessory for archiving in an SRAM.

In the photo edit mode, the user interface display 116 may have a floating toolbar of paint functions together with a display of current foreground and background colors and the current brush width. The toolbar may be activated by pressing the select button 110, and a required tool may be selected using the direction pad 106 and the ‘A’ button 112.

The tools available from the toolbar may include one or more of, but not limited to, a paintbrush (e.g., freehand drawing), an eraser, straight line drawing, rectangle drawing, square drawing, text entry, undo, redo, save, load and save a copy. For example, if the foreground or background color is selected, a color selector is displayed. Further, if the brush width option is selected, the brush width selector may be displayed. When the picture is ready to be returned to archive memory, for example, the start button 108 may be pressed to exit back to the photo snap application. The features of the user interface display should be familiar to most home computer users.

In the spy-cam mode, pictures may be taken automatically at regular intervals, e.g., once every minute) and/or when significant changes have occurred to the image over the previous frame in “image motion check” (i.e., motion detection). The amount of difference between frames to signify significant changes may be altered in an exemplary embodiment according to the present invention. While in the spy-cam mode, the next picture can be taken immediately by pressing the right shoulder button 118.

When the slide show mode is entered, the archived images may be displayed one by one. The images may be advanced to the next image automatically or one or the buttons may be used to advance the image to the next. While in the automatic advance mode, a picture may be skipped or advanced faster, a previous picture may be displayed, the current picture may be held, the time interval between the images may be adjusted (sped up or down) and/or the pictures may be reshuffled, using various different buttons and/or the direction pad.

In the PC link mode, the memory of the digital camera may be formatted (e.g., erased) completely or partially. The digital camera may send one or more, up to all, pictures in its memory to the PC over a serial connection. The digital camera may also receive one or more pictures from PC and store it in the memory of the portable video game device and/or the digital camera accessory. In an exemplary embodiment, the images sent to and received from the PC may be 640×480 16 bit images, 356×292 16 bit images and/or 240×160 16 bit images. In other embodiments, the image size and the number of bits in each pixel of the image may be different, and both the image size (resolution) and bits per pixel may be adjusted. Further, the pictures may be in JPEG, TIFF, BMP or any other format known to those skilled in the art.

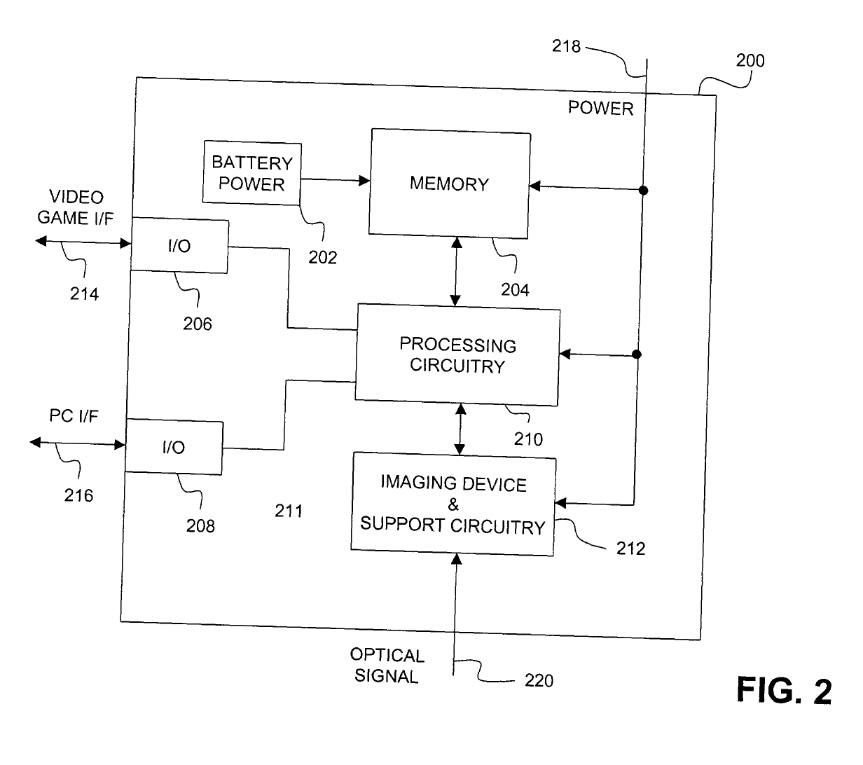

FIG. 2 is a block diagram of a digital camera accessory 200 in an exemplary embodiment according to the present invention. The digital camera accessory 200, for example, may be used as the digital camera accessory 118 of FIG. 1. The digital camera accessory 200 includes memory 204 (e.g., static RAM), processing circuitry 210, an imaging device (e.g., semiconductor based, such as a CMOS imager) & support circuitry 212. The processing circuitry 210 may include a microprocessor (a central processing unit (CPU)) or a micro-controller, and may include other circuitry and/or logic. The processing circuitry 210, for example, may include a Sunplus™ CPU. Sunplus™ is a trademark of Sunplus Technology Co., LTD., a Taiwan corporation. The imaging device & support circuitry 212 may include an optical lens to receive an optical signal 220.

In an exemplary embodiment, the memory 204 includes 512K bytes of static RAM (SPAM), and may be used as an archive memory. Some of the memory should be reserved for a raw image that can take up to 102K bytes in size (356×292×8 bits companded (from 10 bit)) in the exemplary embodiment. This leaves 410K for picture archival, buffers and options backup in the exemplary digital camera accessory having 512K bytes of memory. When used, a JPEG of such an image could compress it down to less than 20K, and this gives a theoretical maximum of 20 images in the archive. More images may be stored by using a smaller (e.g., 240×160) image size.

The digital camera accessory 200 also includes I/O ports 206 and 208 for interfacing with a portable video game device and a PC, respectively, over a video game interface 214 and a PC interface 216. The uncompressed image may be sent in ‘thumbnail’ form (256 color, 120×80 pixels) to the portable video game device for quick viewing. The resultant 9600 bytes may take about 1 second at a rate of 115,200 Bit baud. The whole uncompressed image may also be sent, taking up at least 102K for processing. This may take about eight seconds, for example, in the exemplary embodiment.

If there is enough memory in archive RAM, a second copy of the image may be made before transmission to allow a second picture to be taken within about one second of the first. The camera's own speed should be considered here as well. JPEG or any other image compression on the portable video game device may take several seconds depending on method and available memory. Once the portable video game accessory has completed processing the image, it may be sent back as a 240×160 pixel JPEG or a 356×292 true color JPEG depending the options selected. This may take about two seconds, for example, in the exemplary embodiment.

The communication through I/O port 208 over the PC interface 216 with a PC may also take place at 57,600 bit baud or about 7K bytes a second. Hence, the JPEG may copy in about seven seconds if full speed is possible. Conversion to other formats may take place on the PC itself to keep the speed of transfers reasonable. Different bit bauds and transfer speeds may be used in other embodiments.

The digital camera accessory 200 receives power 218 from the portable video game device or any other suitable power source. The digital camera accessory 200, for example, may receive the power 218 from the portable video game device over the mini-USB port (e.g., the i/o port 206). The digital camera accessory 200 also includes one or more batteries (e.g., watch batteries) as battery power 202 as backup for keeping the images archived in the memory 204, for example. The battery power 202 may also be used to store the default options for the digital camera accessory.

The digital camera accessory 200 is used as the master in the multi-boot sequence in an exemplary embodiment. The portable video game device generates a random number and provides to the digital camera accessory. The portable video game device also provides power to the digital camera accessory over the serial bus. The digital camera accessory includes a processor circuitry, which may be ASIC and may include 6502 micro-controller available from Sunplus Technology Co., LTD. The ASIC may include a small amount of work space RAM to store the random number sent by the portable video game device. In other embodiments, the random number may be stored in the memory 204.

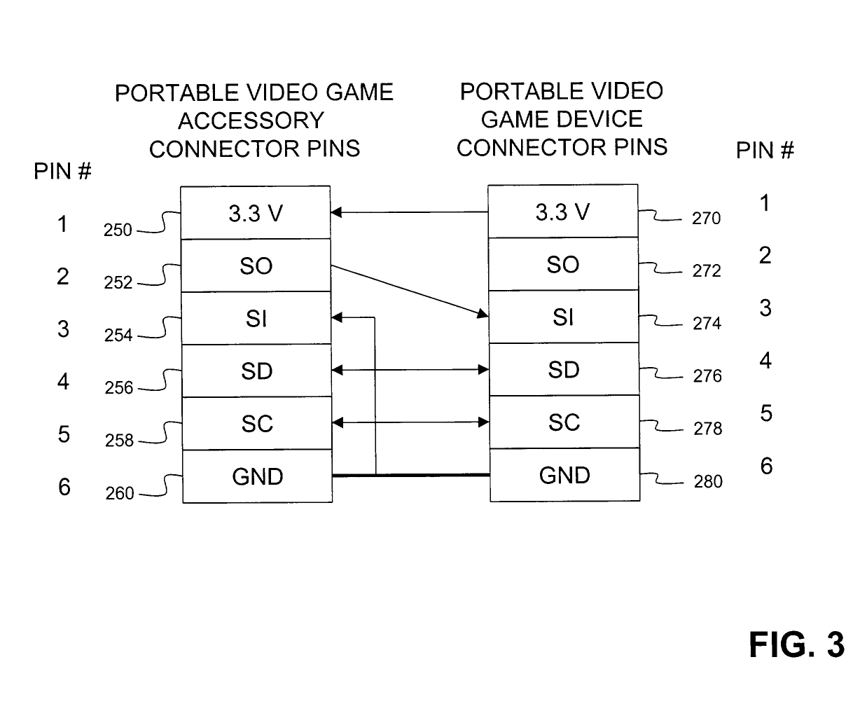

FIG. 3 illustrates pin connections between a portable video game accessory (a digital camera accessory or a networking accessory) and the portable video game device in an exemplary embodiment according to the present invention. In this embodiment, the portable video game accessory is configured as a master while the portable video game device is configured as a slave. The pin numbers are for the mini-USB port. The digital camera accessory has a 3.3V pin 250, an SO pin 252, an SI pin 254, an SD pin 256, an SC pin 258 and a GND pin 260. The portable video game device has a 3.3V pin 270, an SO pin 272, an SI pin 274, an SD pin 276, an SC pin 278 and a GND pin 280. Of course, the number of pins, assigned pin numbers and their names may be different in other embodiments.

As can be seen from FIG. 3, the portable video game device provides 3.3V power from the 3.3V pin 270 to the 3.3V pin 250 of the digital camera accessory. The digital camera accessory provides a synchronization (“sync”) signal from the SO pin 252 to the SI pin 274 of the portable video game device. The SD, SC and GND pins 256, 258, 260 of the digital camera accessory pins are coupled to the SD, SC and GND pins 276, 278, 280 of the portable video game device, respectively. The SI pin 254 of the digital camera accessory is coupled to ground via the GND pin 260.

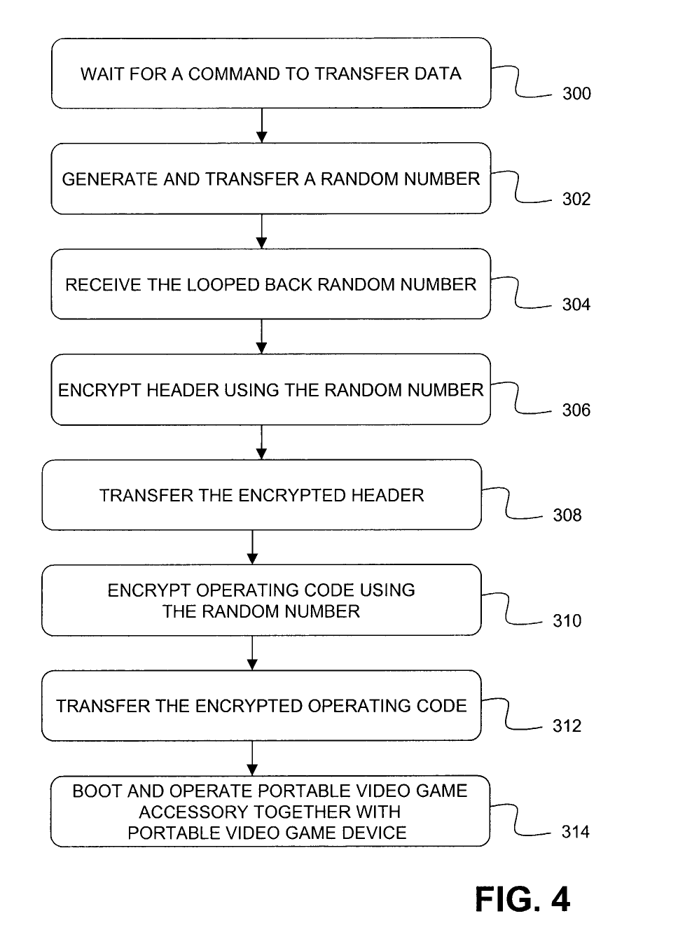

FIG. 4 is a flow diagram illustrating a process of synchronization between a portable video game accessory (e.g., a digital camera accessory or a networking accessory) and a portable video game device in an exemplary embodiment according to the present invention. In step 300, the portable video game device waits for a command to transfer data. In the described embodiment, such command may be provided, for example, by asserting logic high (i.e., “1”) at both the SD pin 256 and the SC pin 258.

In response to the command to transfer data, the portable video game device in step 302 generates a 16-bit random number and transfers it to the portable video game accessory. The 16-bit random number, for example, may confirm a presence of the portable video game device to the portable video game accessory. The random number may be transferred, for example, from the SD pin 276 of the portable video game device to the SD pin 256 of the portable video game accessory. In other embodiments, the random number may have more or less than 16 bits.

In step 304, the portable video game device receives the random number back from the portable video game accessory. In step 306, the digital camera accessory uses the random number to encrypt a header and sends the encrypted header to the portable video game accessory in step 308 to confirm the receipt of the random number.

In step 310, the digital camera accessory encrypts an operating code using the random number and transfers the encrypted operating code to the portable video game device in step 312. The portable video game device decrypts the operating code and stores the operating code in its memory for booting and/or operations. Once the portable video game device is booted, the portable video game device and the portable video game accessory together operate as a digital camera (in case of a digital camera accessory) or as a wireless communicator (in case of a networking accessory).

The portable video game accessory also has a serial port (e.g., DB-9 connector) for communicating with a PC. The PC link may include 5V (or 3.3V), GND, Tx and Rx connections. On the portable video game accessory side, the wires may be wired to an UART (Universal Asynchronous Receiver/Transmitter). The PC link data transfer may be realized using 115,200 bit baud 8N1 protocol (8 or 16 data bits, no parity and 1 stop bit), for example. In other embodiments, different protocol, bit bauds, etc. may be used for the data transfer.

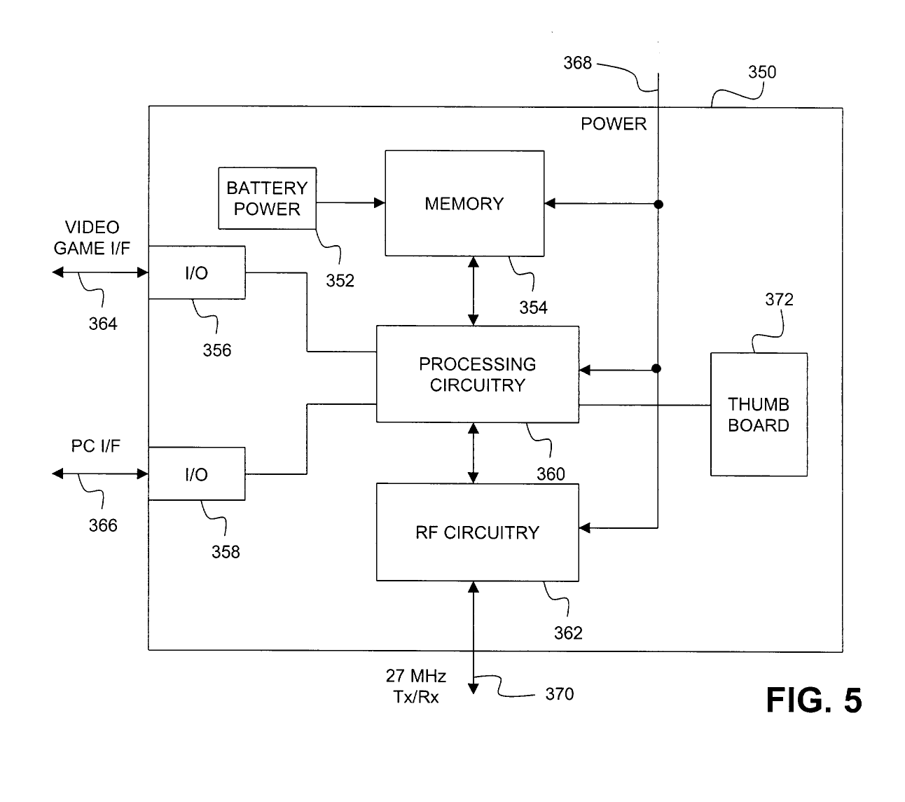

FIG. 5 is a block diagram of a networking accessory 350 in an exemplary embodiment according to the present invention. For example, the networking accessory 350 may be used together with a portable video game device as a wireless communicator that transmits and receives text messages within a group of friends over an area up to hundreds of feet apart. In other embodiments, the range of the wireless communicator may be more or less, depending on such factors as the RF transmission power, obstacles in the RF signal path, etc.

The networking accessory 350 may also have personal data assistant (PDA) functions including, but not limited to, memory for messages and notes. The device provides for a wireless communication in the form of two-way text transmission and reception. It may also use separate batteries to maintain a list of messages and notes internally. In other embodiments, the networking accessory may also support two-way voice communications.

The networking accessory 350 includes memory 354 (e.g., static RAM), processing circuitry 360 and RF (radio frequency) circuitry 362. The processing circuitry 360 may include a microprocessor (a central processing unit (CPU)) or a micro-controller, and may include other circuitry and/or logic. The processing circuitry 360 may include an ASIC and may include 6502 micro-controller available from Sunplus Technology Co., LTD., or any other suitable microprocessor. The microprocessor is used for booting of the portable video game device, ROM storage for code for the portable video game device, thumb pad interface, RF packet processing and serial RAM interface (e.g. interface to the memory 354). The processing circuitry 360, for example, may run at 5 MHz.

The ASIC may include a small amount of work space RAM to store the random number sent by the portable video game device. In other embodiments, the random number may be stored in the memory 354. The memory 354 may include a serial RAM with a ultra-low power backup requirement. The serial RAM also has an I²C style serial interface with the processing circuitry 360, for example.

The RF circuitry 362 may include a Sunplus 27 MHz RF board for bi-directional data communication at 9600 bit baud, and provides a capability for wireless communications with other wireless communicators (e.g., at 27 MHz). In other embodiments, the communication frequency may be different, for example, at 900 MHz or 2.4 GHz. In still other embodiments, more than one communication frequencies may be supported by the networking accessories.

In an exemplary embodiment, the memory 354 includes 512K bytes of static RAM (or serial RAM), and may be used as an archive memory. The memory may be used to store text messages during chat, e-mail, etc. The memory may also be used to store images, such as, for example, the images from a digital camera accessory. In other embodiments, the memory may be more or less than 512K bytes, and may include other types of read-only or random access memories.

The networking accessory 350 also includes I/O ports 356 and 358 for interfacing with a portable video game device and a PC, respectively, over a video game interface 364 and a PC interface 366. The communication through I/O port 358 over the PC interface 366 with a PC may also take place at 115,200 bit baud (or less) or about 13K bytes a second. In other embodiments, the communication over the PC interfaces may take place at the maximum data rate of more or less than 115, 200 bit baud.

The i/o port 356 in the exemplary embodiment is a serial connector (e.g., mini-USB port). The networking accessory 350 may receive 3.3 V power over the video game interface 364 through the i/o port 356. The i/o port 356 is used to communicate multi-boot, to transfer bulk of the portable video game device code from Sunplus ROM (e.g., in the processing circuitry 360), to move data packets to a from the memory 354 (e.g., serial RAM), and to draw operating current for: the processing circuitry 360, the RF circuitry 362, the thumb board 372 (e.g., via the processing circuitry 360) and the memory 354.

The networking accessory 350 receives power 368 from the portable video game device (through the i/o port 356, for example) or any other suitable power source. The networking accessory 350 also includes one or more batteries (e.g., watch batteries) as battery power 352 as backup for keeping the text messages and/or images archived in the memory 354, for example. The battery power 352 may also be used to store default options, if any, programmed for the networking accessory 350. The batteries should be easy to access and to change, and should support a plastic ‘remove me’ pull out.

Similar to the digital camera accessory, the networking accessory is used as a master in the multi-boot sequence. The portable video game device generates a random number and provides to the networking accessory. For example, the above-described flow diagram of FIG. 4 illustrates a synchronization process between a portable video game accessory (e.g., networking accessory) and a portable video game device in an exemplary embodiment according to the present invention. The portable video game device may also provide power to the networking accessory over the serial bus.

The modes of operation provided for by the networking accessory may include one or more of, but not limited to, the following: 1) Friend Seeking; 2) Notepad; 3) Chat Room; 4) Mail Room; 5) Biorhythms; 6) Contact List; 7) To Do List; 8) Help; 9) Multi-Language Support; 10) User Options; 11) Message Ready Ringer and Flashing Icon; 12) Multiple User Chat Room options; and 13) Quick Find function for alphabetically searching contacts.

During the Friend Seeking mode, the wireless communicator scans at all times to check for local network usage. Any other compatible unit (e.g., another wireless communicator) in range will be eavesdropped on to determine network traffic and local users. The wireless communicator may display an active list of local users, for example, in a form of a list box with scroll option. After a period of inactivity, an inactive user may be dropped from the active list. Users may be added to a contacts list by scrolling to them and pressing an appropriate button, such as the ‘B’ button 114 of FIG. 1A. Further, a chat may be requested, for example, by pressing the ‘A’ button 112 after scrolling to a particular user in the active list.

While in the Notepad mode, text messages of variable length may be created. For example, the text messages in an exemplary embodiment may have up to 128 bytes in size. The text messages may be saved as notes using the first word as a title. In the notepad mode, a user may search through all compatible note files using a scrollable list box.

In other embodiments, the text messages may also include other data such as, for example, to, from, subject, priority and folder, etc. depending on its previous life (e.g., who originated parts of the text message when). Further, the user should be able to edit all items (except contacts) while in the Notepad mode. In the exemplary embodiment, up to 256 files (notes or otherwise) may be saved. In other embodiments, the number of files that can be saved may be more or less than 256.

A user may enter the Chat Room mode by selecting an active user in the local area. If no one is active, the user may be seen as ‘traffic’ by entering the Friend Seeking (or Friend Seeker) mode. This mode is explained in more detail in reference to the Multiple User Chat Room mode below.

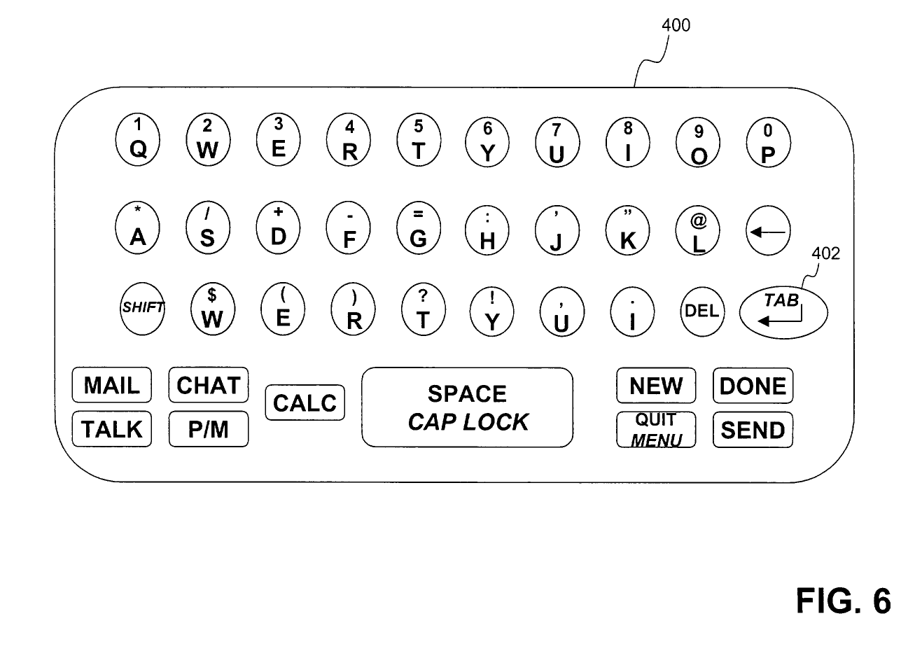

In a chat room, a user may enter text using a thumb pad (or thumb board) which may, for example, be positioned at the base of the display screen of a portable video game device. FIG. 6 illustrates an exemplary thumb board 400, which for example, may be used as the thumb board 372 of FIG. 5. The thumb board 400 has QWERTY style alphabet layout with numbers, simple one touch function access and a basic symbol set. Of course, those skilled in the art would appreciate that the thumb board 400 may be shaped or sized differently than the thumb board 400 of FIG. 6 without departing from the spirit or scope of the present invention. Further, the key layout and the number/type of keys provided may be different in other embodiments. The thumb board should be ergonomically designed so that a user of the wireless communicator can enter information with relative ease.

In an exemplary embodiment, up to 128 characters may be stored between transmissions. In other embodiments, more or less than 128 characters may be stored between transmissions. The stored text message may be transmitted by pressing an enter key 402 and/or a ‘SEND’ key to send. Any transmission visible in the chat room may be displayed in a scrollable text box filling the display screen at least partly. The scrolling of the text box may be achieved using the thumb board and/or the buttons of the portable video game device. In an exemplary embodiment, older incoming messages may be erased when new incoming messages are received when the memory or buffer is full.

The Mail Room mode, for example, may be entered by pressing the ‘MAIL’ key of the thumb board 400. The user may create a mail message by selecting a recipient from his contacts list box or typing in a user ID. The user may also import a note (using a text scroll box for the first words) or even save a message as a note or reply/forward to an existing message. In an exemplary embodiment, folders may be available and may be named/re-named. In an exemplary embodiment, the names of folders may be up to 12 characters in length and may appear in red in the scroll box. The folder data may be stored in the memory 354.

In the Biorhythms mode, by entering a birth date and a target date, a user may obtain a chart of his biorhythms and a textual comment. The thumb board may be used to enter the dates. Using the controls on the portable video game device and/or the thumb pad, the user may move the ‘current date’ along by days, weeks or months to see how the user may perform in the future, or how he performed in the past.

The user may add a Contact List from the friend finder area (e.g., while in the Friend Seeking mode), chat room or mail room. New contacts may also be created using the thumb board. The To Do List is an ordered list box of notes which are sorted on a priority number (e.g., 1 being the highest). A note may be imported from or exported to the general list of notes, contacts and messages.

The user may enter the Help mode at any time. Further, the user may have access to context sensitive help through a one-line text bar at the base of the screen. As a user moves around the possible options using the directional pad of the portable video game device, a scrolling message may inform the user what the option is for. The user may hit the left shoulder button to fill the display with a help screen, for example, and the help screen may take the user through an animated sequence of instructions with sound effects and text bubbles for guiding the user through each step of operation.

The user may use the Multi-Language Support mode to have up to five languages supported in an exemplary embodiment. In other embodiments, more or less than five languages may be supported. User options may be selected using a select button 110, for example. The user may also change his ID (e.g., 12 characters), ‘catch phrase’ (e.g., up to 128 characters) and/or his ‘web page’. The web page may include a single message worth of text plus the display of one or two icons stored in the program.

In other embodiments, the networking accessory may be coupled over a serial link to the digital camera accessory and/or a PC to import a ‘thumbnail’ or two, for example, of the user and/or a favorite place.

An incoming message may generate a sample of ‘you have e-mail’ message. Also a chat request may display ‘hey’ on the screen. The screen may have a hardware sprite smoothly scroll up from the bottom right hand corner displaying either an envelope or a face with open mouth. The help line at the bottom may display the user's name if it is a face (chat request) or the name and first few words of the subject if it is a message.

Using the Multiple User Chat Room option, multiple users may chat at once in a chat room. For example, in an exemplary embodiment, up to four users may chat in a chat room. In other embodiments, the number of users in a chat room may be more or less than four. Both public and private rooms may be provided. All public messages sent may appear in the public room.

The user has an option to invite people into his private room. Any invitee to the chat room may also invite others into the chat room. Thus, if a user adds a friend and his friend in turn adds another friend, there will be three users in the same chat room. As private rooms may be entered by invitation only, they use a random number to uniquely protect what are actually open chats.

When a user switches off his wireless communicator, he may lose the private access but the other users may continue without the switched-off user as they have received a propagated random number associated with the chat. The switched-off user must be re-invited to join in or get lucky and happen to have the same random number when he switches back on. The chance of randomly matching the random number is one out of four billion 32-bit numbers.

Hence many chat rooms may be running in an area, but a user may typically have only one private room open at a time. It should be noted that if a user is invited into a private chat room by some one else, the invited user must leave the current one (e.g., private chat room created by the user) in order to enter the private chat room that he has been invited to enter. The user then should request a re-invite to return using a public chat room, even if the user originally created the private chat room that he is seeking to re-enter.

All notes, contacts and other files may have a sort done on the first word. The file type can also be filtered, as can the four user definable folders. The sort may be tuned to take into account the speed of serial RAM.

The case for the networking accessory should fit to the target portable video game device, and should incorporate and place the thumb board (i.e., thumb pad) beneath screen. The networking accessory should allow serial port connect (draws operating current from GBA serial port) to shield from aerial (e.g., antenna), and to allow shielding of 27 MHz chipset from rest of unit.

In yet another exemplary embodiment, the networking accessory may also have the functions of the digital camera accessory. In this embodiment, the networking device may be used to send pictures and/or video over the small private network. The networking device may be configured to take video/pictures remotely and to send the video/pictures to any other networking device. In a sense, the functions of the digital camera accessory and the networking accessory may be combined into a single portable video game accessory in this embodiment.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive. For example, the present invention has been described mainly in reference to Nintendo® Game Boy Advance®. However, those skilled in the art would appreciate that the principles embodied in the present invention may be broadly applicable to other portable game accessories and/or a similar device.

What is claimed is:

1. A portable video game accessory capable of loading an operating code into a portable video game device having a display panel and a plurality of buttons, said portable video game accessory comprising:
processing circuitry capable of receiving a random number from the portable video game device;
an i/o port suitable for being coupled to the portable video game device; and
a memory capable of storing the operating code and the random number,
wherein the processing circuitry encrypts the operating code using the random number and provides the encrypted operating code to the portable video game device through the i/o port, wherein the operating code enables a user to control the portable video game accessory using the buttons of the portable video game device and to display an output of the portable video game accessory on the display panel.

2. The portable video game accessory of claim 1, wherein the portable video game device has a game slot capable of receiving and holding a video game cartridge, and wherein the portable video game accessory can be inserted at least partly into said game slot to provide a stable mechanical coupling between the portable video game device and the portable video game accessory.

3. The portable video game accessory of claim 2, wherein the portable video game accessory further makes an electrical connection with the portable video game device through the game slot.

4. The portable video game accessory of claim 1, wherein the portable video game device is a Nintendo® Game Boy Advance®.

5. The portable video game accessory of claim 1, further comprising a second i/o port suitable for interfacing with a personal computer.

6. The portable video game accessory of claim 5, wherein the portable video game accessory can be programmed through the second i/o port.

7. The portable video game accessory of claim 1, wherein the portable video game accessory is a digital camera accessory that can be used together with the portable video game device as a digital camera to capture an image.

8. The portable video game accessory of claim 7, wherein the digital camera is capable of editing the captured image.

9. The portable video game accessory of claim 7, wherein the digital camera is capable of being used as a spy-cam capable of taking pictures at regular intervals.

10. The portable video game accessory of claim 7, wherein the digital camera is capable of being used as a spy-cam capable of capturing an image when a significant change between successive images has been detected.

11. The portable video game accessory of claim 7, wherein the digital camera is capable of displaying a slide show of pictures in its memory on the display panel.

12. The portable video game accessory of claim 7, further comprising a second i/o port suitable for interfacing with a personal computer, wherein the portable video game accessory is capable of downloading the captured image to the personal computer through the second i/o port.

13. The portable video game accessory of claim 12, wherein the portable video game accessory is capable of receiving a picture from the personal computer through the second i/o port.

14. The portable video game accessory of claim 1, further comprising RF circuitry, wherein the portable video game accessory is a networking accessory that can be used together with the portable video game device as a wireless communicator.

15. The portable video game accessory of claim 14, wherein the wireless communicator is capable of supporting at least one function selected from a group consisting of e-mail, chat, personal data assistant (PDA), notepad, biorhythms and multiple language support.

16. The portable video game accessory of claim 14, wherein the wireless communicator is capable of bi-directional voice communications.

17. The portable video game accessory of claim 14, wherein the portable video game accessory further functions as a digital camera accessory that can be used together with the portable video game device as a digital camera to capture an image,
wherein the captured image can be transmitted using the RF circuitry.

18. A method of loading an operating code into a portable video game device from a portable video game accessory, said portable video game device having a display panel and a plurality of buttons, the method comprising:
sending a signal from the portable video game accessory to the portable video game device to send a random number;
generating the random number in the portable video game device;
sending the random number to the portable video game accessory;
sending the operating code from the portable video game accessory to the portable video game device; and
operating the portable video game device using the operating code from the portable video game accessory,
wherein the operating code enables a user to control the portable video game accessory using the buttons of the portable video game device and to display an output of the portable video game accessory on the display panel.

19. The method of claim 18, further comprising looping the random number back to the portable video game device.

20. The method of claim 18, further comprising encrypting the operating code using the random number prior to sending it to the portable video game device.

21. The method of claim 20, further comprising decrypting the encrypted boot code in the portable video game device after receiving it from the portable video game accessory.

22. The method of claim 18, further comprising:
encrypting a header in the portable video game accessory using the random number; and
sending the encrypted header to the portable video game device to confirm the receipt of the random number.
